(19) United States
(12) Patent Application Publication
(10) Pub. No.: US 2008/0123979 A1
(43) Pub. Date: May 29, 2008

(54) METHOD AND SYSTEM FOR DIGITAL IMAGE CONTOUR REMOVAL (DCR)

(76) Inventor: Brian Schoner, Freemont, CA (US)

Correspondence Address: MCANDREWS HELD & MALLOY, LTD, 500 WEST MADISON STREET, SUITE 3400, CHICAGO, IL, 60661, US

(21) Appl. No.: 11/563,426

(22) Filed: Nov. 27, 2006

(51) Int. Cl. G06K 9/36; G06K 9/40

(52) U.S. Cl. 382/242; 382/264

(57) ABSTRACT

Aspects of a method and system for digital image contour removal (DCR) are provided. Digital image contours resulting from video compression may be detected in a portion of a video image by determining a variance within a search window. The variance may be compared to a threshold value for selecting the appropriate search window size. The variance may be adjusted to account for image brightness via a programmable offset value. A low pass filter having a window size that matches that of the selected search window size may be utilized to remove the detected digital image contours. Half-toning may be utilized to smooth out results for 8-bit digital video outputs. Half-toning may be based on a combination of ordered and random dither. Removal of digital image contours in video images may be performed in combination with the removal of mosquito noise and/or block noise in the video image.

### CROSS-REFERENCE TO RELATED APPLICATIONS/INCORPORATION BY REFERENCE

This application makes reference to:
U.S. application Ser. No. 11/087,491, filed on Mar. 22, 2005;
U.S. application Ser. No. 11/090,642, filed on Mar. 25, 2005; and
U.S. application Ser. No. 11/089,788, filed on Mar. 25 2005.

Each of the above stated applications is hereby incorporated by reference in its entirety.

### FIELD OF THE INVENTION

Certain embodiments of the invention relate to video processing. More specifically, certain embodiments of the invention relate to a method and system for digital image contour removal (DCR).

### BACKGROUND OF THE INVENTION

Advances in processing techniques for audio-visual information, such as video compression techniques, for example, have resulted in cost effective and widespread recording, storage, and/or transfer of movies, video, and/or music content over a wide range of media. The Moving Picture Experts Group (MPEG) family of standards is among the most commonly used digital compressed formats. Other video compression standards may comprise the Advanced Video Codec (AVC) and/or the Windows Media (VC9) codec, for example. A major advantage of MPEG compared to other video and audio coding formats is that MPEG-generated files tend to be much smaller for the same quality. This is because MPEG uses very sophisticated compression techniques. However, MPEG compression may be lossy and, in some instances, it may distort the video content. In this regard, the more the video is compressed, that is, the higher the compression ratio, the less the reconstructed video resembles the original information. Some examples of MPEG video distortion are a loss of texture, detail, and/or edges. MPEG compression may also result in ringing on sharper edges and/or discontinuities on block edges. Because MPEG compression techniques are based on defining blocks of video image samples for processing, MPEG compression may also result in visible “macroblocking” that may result due to bit errors. In MPEG, a macroblock is the area covered by a 16×16 array of luma samples in a video image. Luma may refer to a component of the video image that represents brightness. Moreover, noise due to quantization operations, as well as aliasing and/or temporal effects may all result from the use of MPEG compression operations.

When MPEG video compression results in loss of detail in the video image it is said to “blur” the video image. In this regard, operations that are utilized to reduce compression-based blur are generally called image enhancement operations. When MPEG video compression results in added distortion on the video image it is said to produce “artifacts” on the video image. For example, the term “mosquito noise” may refer to MPEG artifacts that may be caused by the quantization of high spatial frequency components in the image. Mosquito noise may also be referred to as “ringing” or “Gibb's effect.” In another example, the term “block noise” may refer to MPEG artifacts that may be caused by the quantization of low spatial frequency information in the image. Block noise may appear as edges on 8×8 blocks and may give the appearance of a mosaic or tiling pattern on the video image.

In 8-bit video systems, for example, MPEG video compression may also result in digital image contours or bands on smooth gradients. Digital image contours may correspond to noise of one to three quantization levels, that is, low-level contours in a video signal. For example, digital image contours may be visible in both luma and chroma, with noise of one quantization level in chroma U and V components easily translating into noise of 2 or 3 quantization levels in R, G, or B components.

Video artifacts may be more pronounced depending on the video content or the display environment. For example, on a static video scene the artifacts generated by processing operations may be static, such as mosquito noise, or may be dynamic, such as analog-to-digital conversion (ADC noise). Digital image contours, for example, may be accentuated by large, sharp, high-contrast, high-resolution video displays. Digital image contours corresponding to one quantization level may be easiest to see in dark images or in a dark room. Digital image contours may also be easier to see when there is spatial and/or temporal correlation. Moreover, digital image contours may be accentuated by digital video processing operations such as contrast, sharpening, and/or improper rounding, for example.

There may be several differences between mosquito noise, block noise, and/or digital image contours. Mosquito noise, for example, is a block-based coding artifact that appears near strong edges as very high frequency spots or fuzz. Block noise is also a block-based coding artifact generally caused by the quantization of DCT coefficients and appears as a strong screen window. Digital image contours instead may occur from the quantization of video data to 256 levels, that is, to 8-bit values and it is generally visible as long, faint lines or blocks in flat regions. When a higher contrast or a sharper image setting is selected in a video display, for example, the presence of digital image contours may be more visible to a viewer.

While both mosquito and block noise may be removed by applying small, strong digital filters, digital image contours may be difficult to remove. For example, 9-bit or 10-bit video systems may be able to reduce the effects of digital image contours on the output images. However, these video systems may require internal 9-bit or 10-bit processing respectively while most video systems support 8-bit internal processing. Digital filters in 8-bit video systems are ineffective at reducing digital image contours because there are not enough bits to represent the filter output. If 8-bit video data from a video system with an 8-bit internal processing is converted to 10-bit video data, for example, to enable a 10-bit filter to remove the digital image contours, the digital image contours may be recreated when the output of the 10-bit filter is quantized back to 8-bit video data.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for digital image contour removal (DCR), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary video processing system that may be utilized for digital contour removal (DCR), mosquito noise reduction (MNR) and/or block noise reduction (BNR), in accordance with an embodiment of the invention.

FIG. 2 is a diagram illustrating exemplary digital image contours occurring in a digital video image, in accordance with an embodiment of the invention.

FIG. 3A is a block diagram illustrating an exemplary architecture for a digital contour removal system, in accordance with an embodiment of the invention.

FIG. 3B is a block diagram illustrating an exemplary architecture for a system comprising digital contour removal and digital noise removal operations, in accordance with an embodiment of the invention.

FIG. 4A is a block diagram illustrating exemplary line stores for standard definition (SD) applications, in accordance with an embodiment of the invention.

FIG. 4B is a block diagram illustrating exemplary line stores for high definition (HD) applications, in accordance with an embodiment of the invention.

FIG. 5 is a diagram illustrating exemplary search and filtering window for digital contour removal, in accordance with an embodiment of the invention.

FIG. 6A is a block diagram illustrating an exemplary system for gathering vertical and horizontal image statistics to select an appropriate search window size, in accordance with an embodiment of the invention.

FIG. 6B is a block diagram illustrating an exemplary system for gathering horizontal image statistics to select an appropriate search window size, in accordance with an embodiment of the invention.

FIG. 7 is a diagram illustrating exemplary scanning of a video image for digital contour removal, in accordance with an embodiment of the invention.

FIG. 8 is a block diagram illustrating exemplary filter for digital contour removal, in accordance with an embodiment of the invention.

FIG. 9 is a block diagram illustrating an exemplary half-toning system, in accordance with an embodiment of the invention.

FIG. 10 is a block diagram illustrating an exemplary random dither generator, in accordance with an embodiment of the invention.

FIG. 11 is a diagram illustrating exemplary half-toning operation with random dither, in accordance with an embodiment of the invention.

FIG. 12 is a flow diagram illustrating exemplary steps for digital contour removal in video images, in accordance with an embodiment of the invention.

### DETAILED DESCRIPTION OF THE INVENTION

Certain embodiments of the invention may be found in a method and system for digital image contour removal (DCR). Aspects of the invention may comprise detecting digital image contours that result from video compression in a portion of a video image by determining a variance within a search window. The variance may be compared to a threshold value for selecting the appropriate search window size. The variance may be adjusted to account for image brightness via a programmable offset value. A low pass filter having a window size that matches that of the selected search window size may be utilized to remove the detected digital image contours. Half-toning may be utilized to smooth out results for 8-bit digital video outputs. Half-toning may be based on a combination of ordered and random dither. Removal of digital image contours in video images may be performed in combination with the removal of mosquito noise and/or block noise in the video image.

Digital image contour removal may comprise a variable size filter and matching variable size variance calculation. An 8-bit video output may be smoothed for 10-bit video applications or may be half-toned for 8-bit video applications. Filtering in digital image contour removal may be increased in dark regions and filter thresholds may be adjusted based on bitstream Qp parameters, for example. Digital image contour removal may be utilized to improve the quality of low-bit rate video with low-level contours and where fewer bits may be utilized for encoding.

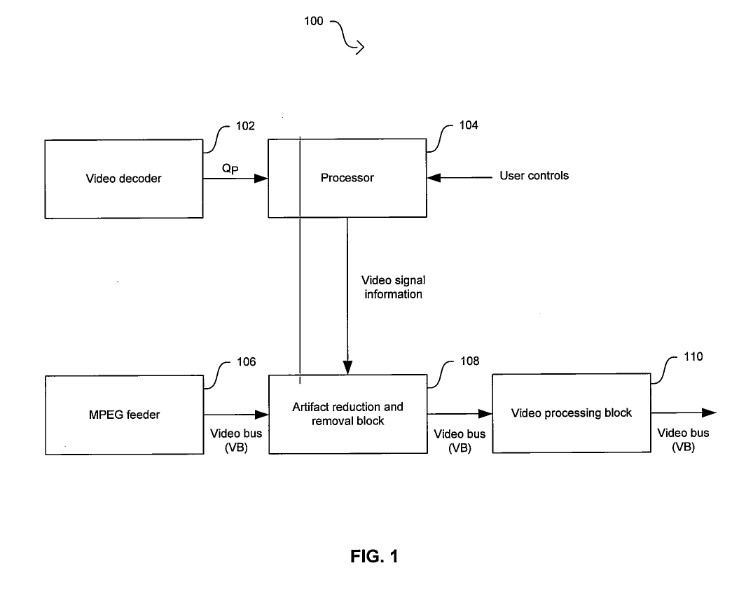

FIG. 1 is a block diagram of an exemplary video processing system that may be utilized for digital contour removal (DCR), mosquito noise reduction (MNR) and/or block noise reduction (BNR), in accordance with an embodiment of the invention. Referring to FIG. 1, there is shown a video processing system 100 comprising a video decoder 102, a processor 104, an MPEG feeder 106, an artifact reduction and removal block 108, and a video processing block 110. In this regard, the video processing system 100 may be an example of a video processing system where the effects of digital image contours or bands, mosquito noise, and/or block noise in the compressed video content are to be reduced and/or removed. The video decoder 102 may comprise suitable logic, circuitry, and/or code that may enable decoding of compressed video information. The host processor 104 may comprise suitable logic, circuitry, and/or code that may enable processing of quantization information, Qp, received from the video decoder 102 and/or user control information received from at least one additional device or processing block. The host processor 104 may enable generation of video signal information that corresponds to a current picture based on the processed quantization information and/or user control information. The generated video signal information may comprise, for example, threshold settings, indications of whether a video field is a top field or a bottom field, indications of whether the video signal is interlaced or progressive, and/or the size of the video image. The host processor 104 may transfer the video signal information to the artifact reduction and removal block 108. In some instances, at least a portion of the video signal information may be received by the artifact reduction and removal block 108 via a register direct memory access (DMA).

The MPEG feeder 106 may comprise suitable logic, circuitry, and/or code that may enable transferring of a plurality of MPEG-coded images to the artifact reduction and removal block 108 via a video bus (VB), for example. In this regard, the VB may utilize a specified format for transferring images from one processing or storage block to another processing or storage block. The artifact reduction and removal block 108 may comprise suitable logic, circuitry, and/or code that may be adapted to reduce some artifacts that may result from MPEG coding. In this regard, the artifact reduction and removal block 108 may enable processing of MPEG-coded images to reduce digital image contours, mosquito noise, and/or block noise. The processing performed by the artifact reduction and removal block 108 may be based on the contents of a current video image and on the video signal information corresponding to that current video image transferred from the host processor 104. The video signal information may be programmed or stored into registers in the artifact reduction and removal block 108 during the vertical blanking interval, for example. This programming approach may reduce any unpredictable behavior in the artifact reduction and removal block 108. The artifact reduction and removal block 108 may enable transferring of processed MPEG-coded images to the video processing block 110 via the VB. The video processing block 110 may comprise suitable logic, circuitry, and/or code that may enable performing various image processing operations such as scaling and/or deinterlacing, for example, on the processed MPEG-coded images received from the artifact reduction and removal block 108.

When the pictures from the MPEG feeder 106 are coded as field pictures they may be transferred to the artifact reduction and removal block 108 as field pictures. When the pictures from the MPEG feeder 106 are coded as frame pictures they may be transferred to the artifact reduction and removal block 108 as frame or field pictures in accordance with the video stream format and/or the display.

The artifact reduction and removal block 108 may also be adapted to provide post-processing operations for the Advanced Video Codec (AVC) and/or the Windows Media (VC9) codec. Deblocking or artifact reduction operations that may be performed by the artifact reduction and removal block 108 may be relaxed for AVC and VC9 because they specify in-loop deblocking filters. For example, AVC transforms may exhibit less ringing than the 8×8 DCT utilized in MPEG. Moreover, while AVC and VC9 allow image block sizes smaller than 8×8 to be utilized, processing at the sub-block level may present some difficulties and the artifact reduction and removal block 108 may enable performing deblocking filtering for AVC and VC9 without sub-block processing.

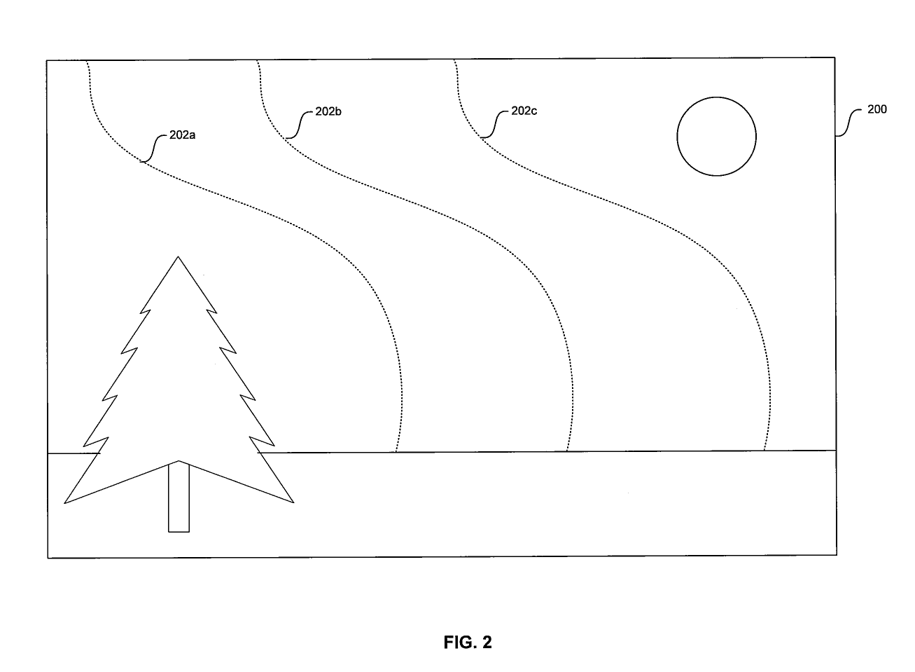

FIG. 2 is a diagram illustrating exemplary digital image contours occurring in a digital video image, in accordance with an embodiment of the invention. Referring to FIG. 2, there is shown a video image 200 that may illustrate an exemplary 8-bit video image comprising digital image contours. Contour lines 202a, 202b, and 202c may indicate the boundaries that result from contours or bands in a flat region such as the sky in the background of the video image 200. In some instances, more than one region of the video image 200 may comprise at least one contour line or boundary. The contours or bands may occur from changes of one to three quantization levels to the original digital image as a result of MPEG video compression, for example. In some instances, an average difference of one quantization level between bands may be sufficient to have a contour line visible to a viewer in an 8-bit video system.

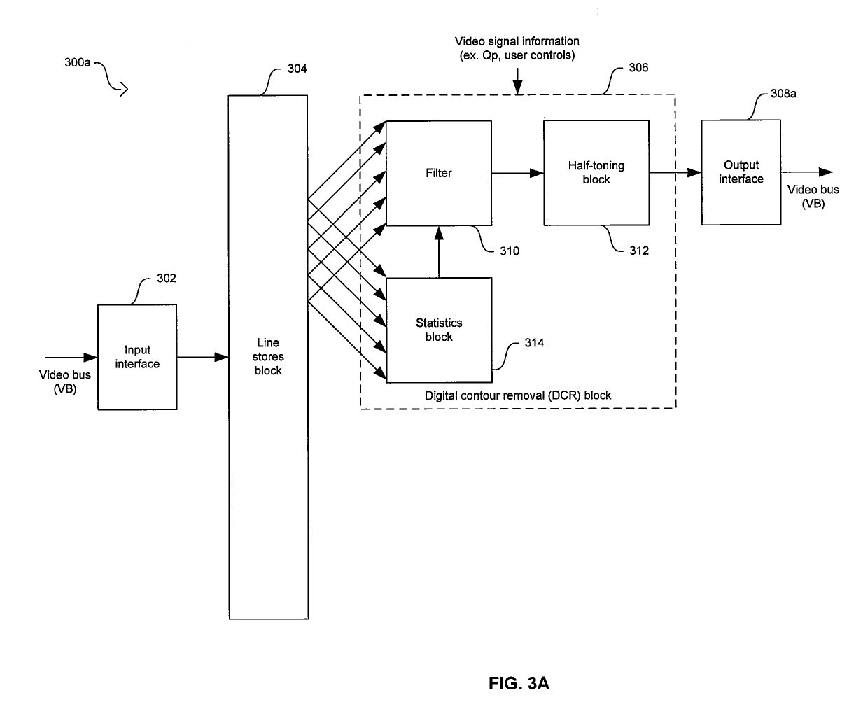

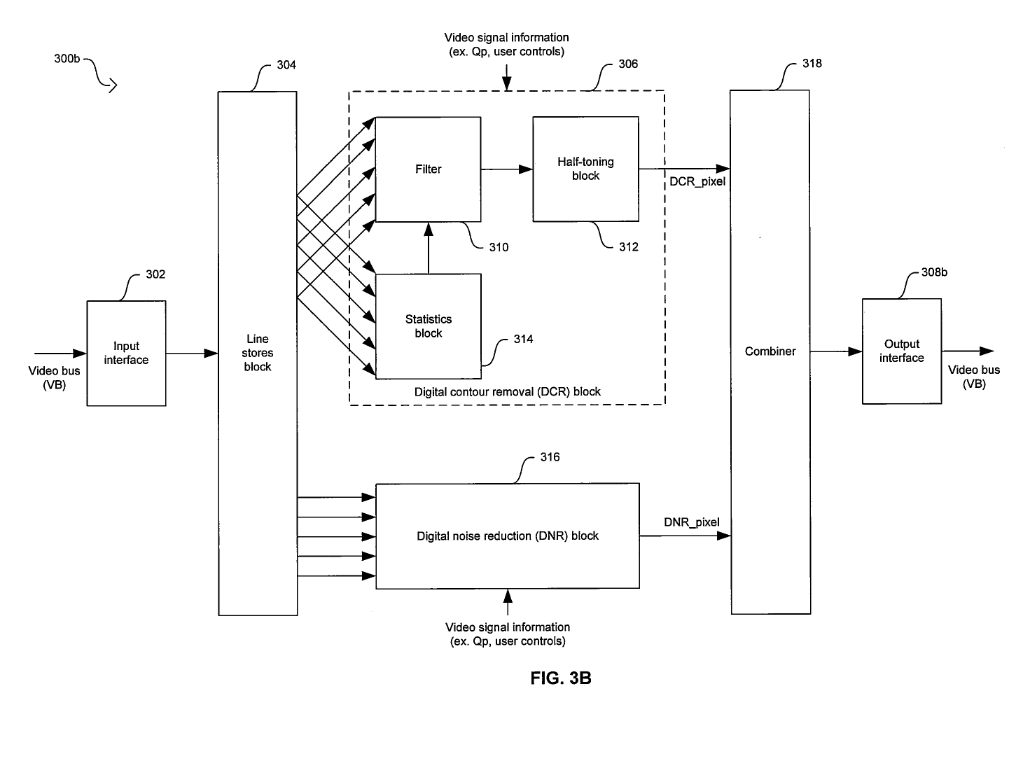

FIG. 3A is a block diagram illustrating an exemplary architecture for a digital contour removal system, in accordance with an embodiment of the invention. Referring to FIG. 3A, there is shown an artifact reduction and removal block 300a that may correspond to the artifact reduction and removal block 108 in FIG. 1. The artifact reduction and removal block 300a may comprise an input interface 302, a line stores block 304, a DCR block 306, and an output interface 308a. The DCR block 306 may comprise a filter 310, a half-toning block 312 and a statistics block 314.

The input interface 302 may comprise suitable logic, circuitry, and/or code that may enable receiving MPEG-coded images in a format that is in accordance with the bus protocol supported by the VB. The input interface 302 may also enable conversion of the received MPEG-coded video images into a different format for transfer to the line stores block 304. The output interface 308a may comprise suitable logic, circuitry, and/or code that may enable assembling of noise-reduced MPEG-coded video images from the half-toning block 312 into a format that is in accordance with the bus protocol supported by the VB. The line stores block 304 may comprise suitable logic, circuitry, and/or code that may enable conversion of raster-scanned video data from a current MPEG-coded video image into parallel lines of video data. The line stores block 304 may enable operation in a high definition (HD) mode or in a standard definition (SD) mode.

The DCR block 306 may comprise suitable logic, circuitry, and/or code that may enable removal of digital image contours from video images. In this regard, the DCR block 306 may enable removal of low-level contours from low-bitrate video, for example. The DCR block 306 may operate on all color components, such as, luma (Y) and chroma (Cb and Cr). The DCR block 306 may utilize, for example, 12-bit processing to internally filter contours. The DCR block 306 may utilize dither or half-toning on the contour-reduced MPEG-coded video outputs. For example, for 10-bit video systems, the output of the DCR block 306 may be dithered to 10-bits while for 8-bit systems the output may be dithered to 8-bits. The DCR block 306 may utilize at least one dither option for processing the video outputs. The operation of the DCR block 306 may be adjusted by, for example, the processor 104 in FIG. 1, based on the bit rate or the Qp of the incoming video bitstream. Moreover, the operation of the DCR block 306 may also be adjusted by, for example, the processor 104, based on user and/or system preferences.

The statistics block 314 may comprise suitable logic, circuitry, and/or code that may enable collecting statistical information from at least a portion of a video image received from the line stores block 304. The statistics block 314 may process the collected statistical information and may select the appropriate digital filter size for filtering the corresponding portion of the video image. In this regard, the statistics block 314 may generate at least one signal to indicate to the filter 310 which digital filter size to utilize for smoothing the portion of the video image. The filter 310 may comprise suitable logic, circuitry, and/or code that may enable filtering a portion of the video image received from the line stores block 304 to remove digital image contours. In some instances, the filter 310 may be implemented using a higher bit internal processing than that of the digital video output of the DCR block 306. For example, the filter 310 may be implemented in 12-bit internal processing while the output of the DCR block 306 may be 8-bit or 10-bit video. The results of the filter 310 may be transferred to the half-toning block 312.

The half-toning block 312 may comprise suitable logic, circuitry, and/or code that may enable dithering of the filtered portions of the video images transferred from the filter 310. The half-toning block 312 may enable a pass through mode where the filtered portions of the video image are not dithered. The half-toning block 312 may provide more than one output format. For example, the output of the half-toning block 312 may be 8-bit video output or 10-bit video. In this regard, the pass through mode may be enabled when the 10-bit video is selected and may be disabled when the 8-bit video is selected. The half-toning block 312 may enable more than one dithering option in processing the results of the filter 310. For example, the half-toning block 312 may provide ordered dither, random dither, and a combination of ordered and random dither. In this regard, the processor 104 in FIG. 1 may be utilized to control the dithering operation performed by the half-toning block 312. The operations performed by the statistics block 314, the filter 310, and/or the half-toning block 312 may be programmable via, for example, the processor 104.

In operation, at least a portion of a video image may be received by the input interface 302 via the VB. The input interface 302 may convert the received video image from the format supported by the VB to a format that enables transfer to the lines stores block 304. The line stores block 304 may store lines of the received video image and may transfer the appropriate video image information to the statistics block 314 and to the filter 310 in the DCR block 306. The statistics block 314 may select the appropriate digital filter in the filter 310 for filtering the corresponding portion of the video image by collecting and processing statistical information. The filter 310 may filter the portion of the video image to smooth out digital image contours by utilizing the digital filter size selected by the statistics block 314. The half-toning block 312 may dither the filtered portion of the video image when appropriate to achieve the proper output bit size. The output interface 308a may convert the output of the half-toning block 312 in the DCR block 306 to the format supported by the VB. Notwithstanding the description provided in FIG. 3A for the artifact reduction and removal block 300a, other embodiments of the invention may be utilized for removal of digital image contours.

FIG. 3B is a block diagram illustrating an exemplary architecture for a system comprising digital contour removal and digital noise removal operations, in accordance with an embodiment of the invention. Referring to FIG. 3B, there is shown an artifact reduction and removal block 300b that may correspond to the artifact reduction and removal block 108 in FIG. 1. The artifact reduction and removal block 300b may comprise the input interface 302, the line stores block 304, the DCR block 306, an output interface 308b, a digital noise reduction (DNR) block 316, and a combiner 318. The DCR block 306 may comprise the filter 310, the half-toning block 312 and the statistics block 314. During operation, the artifact reduction and removal block 300b may enable the operation of the DCR block 306, the DNR block 316, and/or both.

The input interface 302, the line stores block 304, the DCR block 306, the filter 310, the half-toning block 312, and the statistics block 314 may be the same or substantially similar to the corresponding components described in FIG. 3A. The output interface 308b may comprise suitable logic, circuitry, and/or code that may enable assembling of noise-reduced MPEG-coded video images from the combiner 318 into a format that is in accordance with the bus protocol supported by the VB.

The DNR block 316 may comprise suitable logic, circuitry, and/or code that may enable reducing mosquito noise, block noise, and/or a combination of both from a portion of the video image received from the line stores block 304. The output of the DNR block 316, that is, a noise-reduced value of pixels from a portion of the video image, DNR_pixel, may be transferred to the combiner 318. The operation of the DNR block 316 may be adjusted by, for example, the processor 104 in FIG. 1, based on the bit rate or the Qp of the incoming video bitstream. Moreover, the operation of the DNR block 316 may also be adjusted by, for example, the processor 104, based on user and/or system preferences. The U.S. application Ser. No. 11/087,491, filed on Mar. 22, 2005, discloses a method and system for mosquito noise reduction, and is hereby incorporated herein by reference in its entirety. The U.S. application Ser. No. 11/090,642, filed on Mar. 25, 2005, discloses a method and system for block noise reduction, and is hereby incorporated herein by reference in its entirety. The U.S. application Ser. No. 11/089,788, filed on Mar. 25, 2005, discloses a method and system for combining results of mosquito noise reduction and block noise reduction, and is hereby incorporated herein by reference in its entirety.

The combiner 318 may comprise suitable logic, circuitry, and/or code that may enable combining the portion of the video image with reduced digital image contours from the DCR block 306, DCR_pixel, with the corresponding noise-reduced portion of the video image from the DNR block 316, DNR_pixel. The combiner 318 may generate a first difference value, delta_DCR, which is the difference between the output of the DCR block 306 for a current pixel and the original value of the current pixel, that is, delta_DCR=DCR_pixel−original pixel value. The combiner 318 may generate a second difference value, delta_DNR, which is the difference between the output of the DNR block 316 for a current pixel and the original value of the current pixel, that is, delta_DNR=DNR_pixel−original pixel value. When both difference values have the same sign, the combiner 318 may select the one with the largest absolute value as a final delta value or final_delta. When the difference values have different signs, the combiner 318 may add them together and the result is final_delta. The output of the combiner 318 for a current pixel in the portion of the video image under consideration is given by the expression final_pixel=original pixel value+final_delta, where final_pixel is the output pixel value from the combiner 318. Both the DCR block 306 and the DNR block 316 may enable a pass-through mode where the portion of the video image under consideration is passed through without any processing performed on the original pixel values.

In operation, at least a portion of a video image may be received by the input interface 302 via the VB. The input interface 302 may convert the received video image from the format supported by the VB to a format that enables transfer to the lines stores block 304. The line stores block 304 may store portions of a received video image and may transfer the appropriate video image information to the statistics block 314 and to the filter 310 in the DCR block 306 and to the DNR block 316. The statistics block 314 may select the appropriate digital filter in the filter 310 for filtering the corresponding portion of the video image by collecting and processing statistical information, such as variance calculations, for example. The filter 310 may filter the portion of the video image to smooth out digital image contours by utilizing the digital filter size selected by the statistics block 314. The half-toning block 312 may dither the filtered portion of the video image when appropriate to achieve the proper output bit size.

The DNR block 316 may reduce mosquito noise, block noise, and/or both on the portion of the video image received from the line stores block 304. The combiner 318 may combine the results of the DCR block 306 and of the DNR block 316 in accordance with combining weights given to each. The output of the combiner 318 may be a portion of a video image with removed digital image contours and reduced mosquito noise, block noise, and/or both. The output interface 308b may convert the output of the combiner 318 to the format supported by the VB. Notwithstanding the description provided in FIG. 3B for the artifact reduction and removal block 300b, other embodiments of the invention may be utilized for removal of digital image contours and reduction of mosquito noise, and/or block noise.

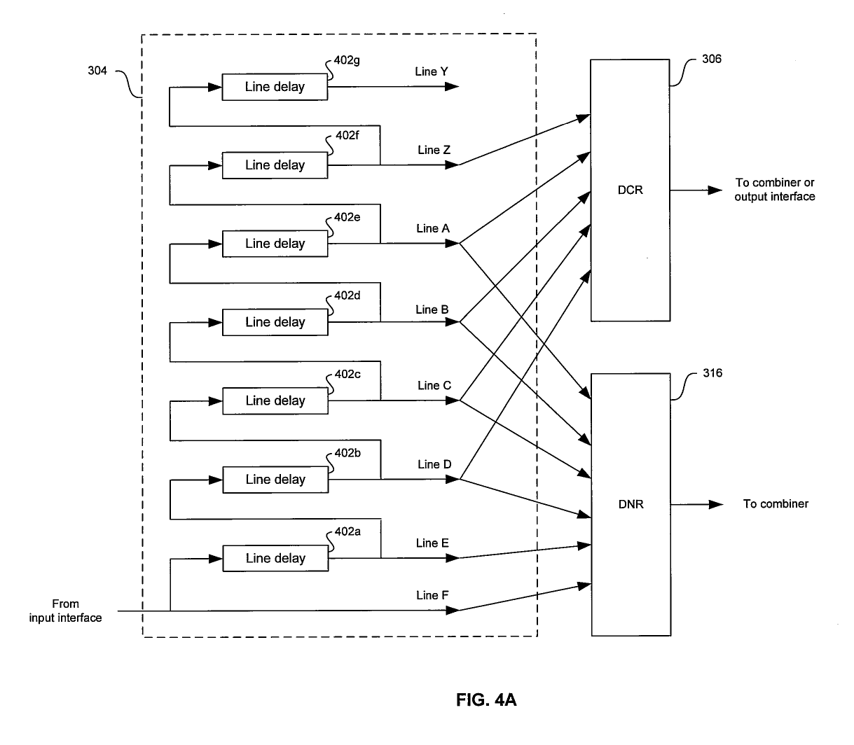

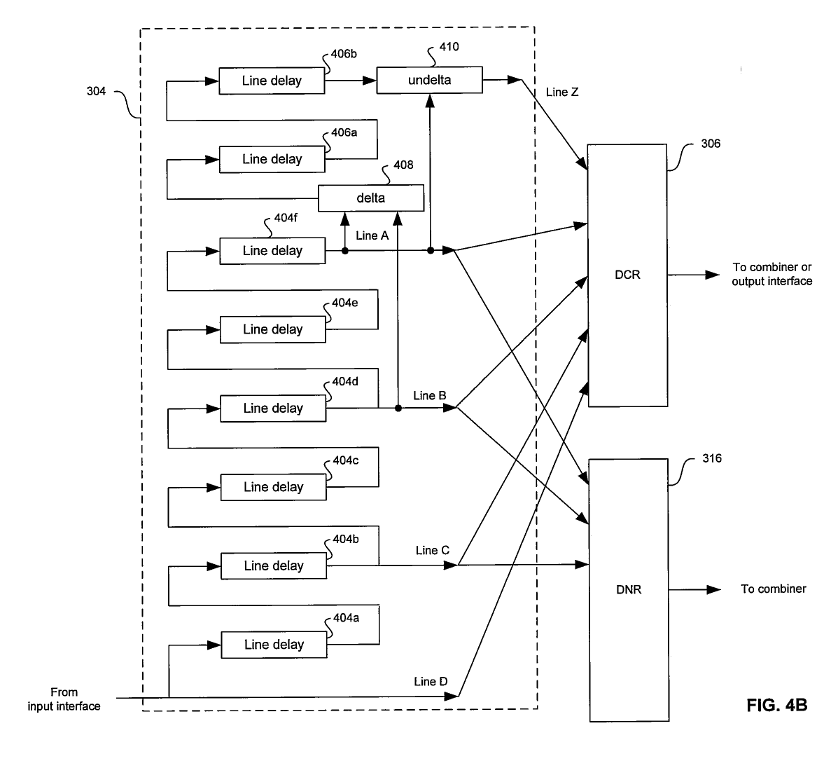

FIG. 4A is a block diagram illustrating exemplary line stores for standard definition (SD) applications, in accordance with an embodiment of the invention. Referring to FIG. 4A, the line stores block 304 may combine line stores necessary for the DCR block 306 with line stores necessary for the DNR block 316. The line stores block 304 may enable operation in a mode that converts SD image sources into output parallel lines for both the DCR block 306 and the DNR block 316. The line stores block 304 may be implemented utilizing a single memory array such as, for example, a 960×112 dual-port memory array. For the SD mode, the line stores block 304 may comprise line delays 402a, . . . , 402g from which output lines F, E, D, C, B, A, Z, and Y may be generated respectively. The DNR block 316 may receive 6 lines, that is, lines A, B, C, D, E, and F, while the DCR block 306 may receive 5 lines, that is, lines Z, A, B, C, and D. Line B is the current output line for both the DNR block 316 and the DCR block 306. Line Y need not be utilized during the SD mode. Each line store may comprise 8-bit 4:2:2 Y Cr Cb video data. In some instances, the line stores block 304 may need to know the raster position relative to image block boundaries. In this regard, the processor 104 in FIG. 1 or a register DMA, for example, may provide offset values when a first raster pixel does not correspond to an image block boundary.

FIG. 4B is a block diagram illustrating exemplary line stores for high definition (HD) applications, in accordance with an embodiment of the invention. Referring to FIG. 4B, the line stores block 304 may enable operation in a mode that converts HD image sources into output parallel lines for both the DCR block 306 and the DNR block 316. The line stores block 304 may be implemented utilizing a single memory array such as, for example, a 960×112 dual-port memory array. For the HD mode, the line stores block 304 may comprise line delays 404a, . . . , 404f, line delays 406a and 406b, a delta 408, and an undelta 410. The line delays 406a and 406b may be 4-bit line delays where the 4-bit input to the line delay 406a may be generated by an operation on output lines A and B at the delta 408. The output lines D, C, B, and A may be generated respectively from the input line from the input interface, from line delay 404b, from line delay 404d, and from line delay 404f. The output line Z may be compressed to 4-bits and may be generated by an operation at the undelta 410 that comprises output line B to the output of the line delay 406b. The DNR block 316 may receive 3 lines, that is, lines A, B, and C, while the DCR block 306 may receive 5 lines, that is, lines Z, A, B, C, and D. Each of the line stores A, B, C, and D may comprise 8-bit 4:2:2 Y Cr Cb video data. In some instances, the line stores block 304 may need to know the raster position relative to image block boundaries. In this regard, the processor 104 in FIG. 1 or a register DMA, for example, may provide offset values when a first raster pixel does not correspond to an image block boundary.

Since the digital image contour removal operation is generally performed over smooth or flat portions of a video image, with few quantization levels, one line store in the line stores block 304 may be compressed to reduce the area required. While a plurality of compression options may be utilized, FIG. 4B illustrates a vertical delta compression based on the delta 408. The delta 408 may comprise suitable logic, circuitry, and/or code that may enable quantizing the difference between output line A and output line B. The line compression operation by the delta 408 may be expressed as Z(in)=quant(A−B). In this regard, both luma and chroma components are compressed and each component difference is quantized to 4-bits. Differences that may fall in the range [−7,7] may be stored without any loss of information while differences that may be greater than [−7,7] may be identified with an escape code, such as [−8], for example. The undelta 410 may comprise suitable logic, circuitry, and/or code that may enable expanding the output line Z by adding the output line A. The expansion of the output line Z may be expressed as Z(out)=Z+A. When the output line Z comprises an escape code, the most significant bit (MSB) of output line A may be inverted to create a large discontinuity that may be skipped by the filters.

The line stores block 304 may be enabled to repeat top/bottom lines at the top/bottom of each video image. Because the active line for the DCR block 306 and for the DNR block 316 may be the same active line, the line repeat operation by the line stores block 304 may be the same for the DCR block 306 and for the DNR block 316. Notwithstanding the description provided in FIGS. 4A and 4B for the line stores block 304, other embodiments of the invention may be utilized for storing video image lines for digital image contour removal and/or noise reduction.

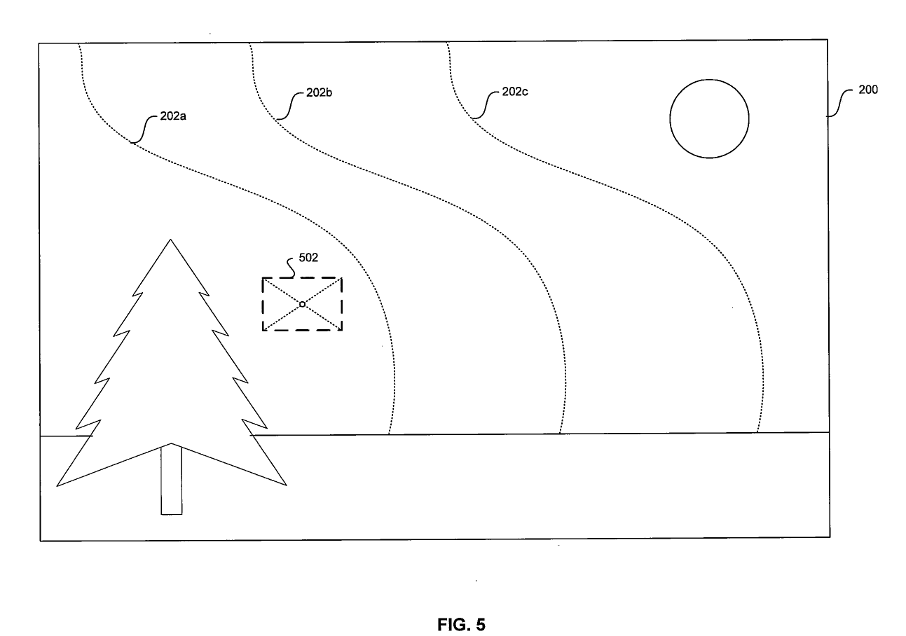

FIG. 5 is a diagram illustrating exemplary search and filtering window for digital contour removal, in accordance with an embodiment of the invention. Referring to FIG. 5, there is shown the video image 200 described in FIG. 2 comprising a search window 502 in a portion of the smooth or flat region of the video image where digital image contours or bands have occurred as a result of video compression operations, for example. The search window 502 may be centered about a current pixel under consideration. The statistics block 314 may utilize the search window 502 to gather statistics for detecting digital image contours or bands and for selecting the appropriate filtering window size for smoothing out the effects of the digital image contours or bands on the video image 200.

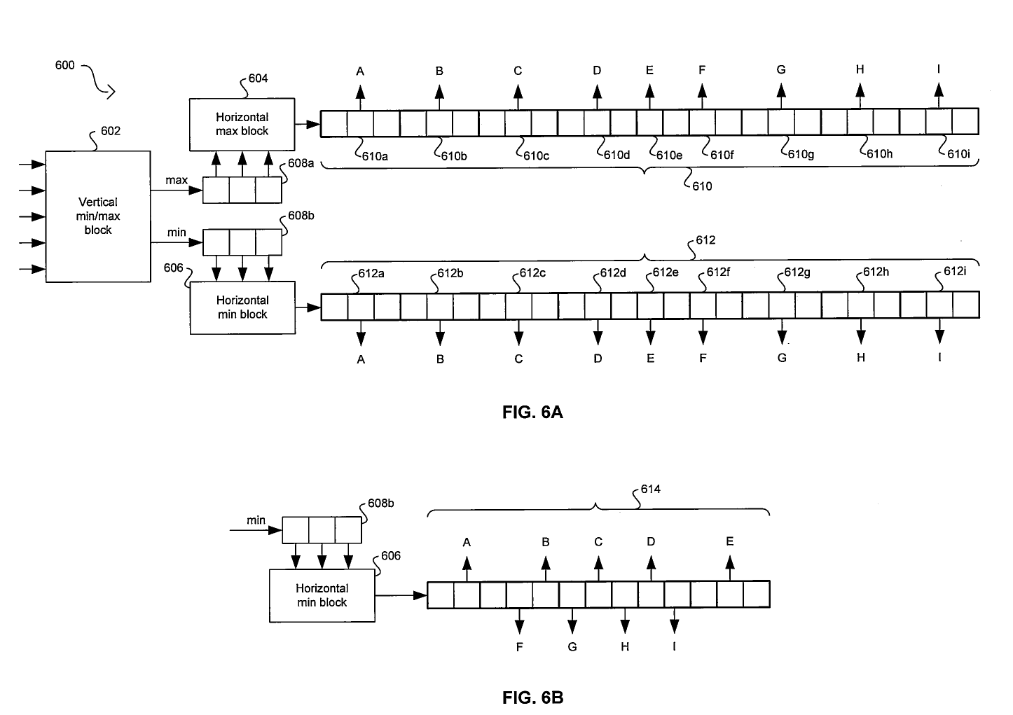

FIG. 6A is a block diagram illustrating an exemplary system for gathering vertical and horizontal image statistics to select an appropriate search window size, in accordance with an embodiment of the invention. Referring to FIG. 6A, there is shown a system 600 that may correspond to a portion of a statistics block 314 in FIG. 3. The system 600 may be utilized to collect statistical information. In this regard, the system 500 may be utilized to determine the minimum (min) and maximum (max) pixel values for luma and chroma components, such as U and V components, for each search window. The search window size may be one of a plurality of determined window sizes. For example, statistical calculations for the pixel luma values within the search window may utilize search window sizes such as 7×5, a 13×5, a 19×5, or a 25×5 window size. Statistical calculations for the pixel chroma values within the search window may utilize decimated search window sizes such as 5×5, 7×5, 9×5, and 13×5 window size, for example.

In one embodiment of the invention, the system 600 may separate the min/max calculations into vertical and horizontal operations and the min/max calculations may be pipelined horizontally. In this regard, the system 600 may comprise a vertical min/max block 602, buffers 608a and 608b, a horizontal max block 604, a horizontal min block 606, buffers 610 and 612.

The vertical min/max block 602 may comprise suitable logic, circuitry, and/or code that may enable receiving five lines of video image information from the line stores block 304. The vertical min/max block 602 may enable determining the minimum and maximum pixel values over the five line stores. In this regard, the vertical min/max block 602 may utilize six comparison operations, for example, to determine the minimum and maximum pixel values from the five line stores. The vertical min/max block 602 may transfer the maximum pixel value to the three-pixel buffer 608a and the minimum pixel value to the three-pixel buffer 608b. The buffers 608a and 608b may comprise suitable logic, circuitry, and/or code that may enable storing of pixel values from the vertical min/max block 602. In one embodiment of the invention, the buffers 608a and 608b may enable storing three pixel values that may be transferred to the horizontal max block 604 and to the horizontal min block 606 respectively.

The horizontal max block 604 may comprise suitable logic, circuitry, and/or code that may enable determining a maximum pixel value from the pixel values transferred from the buffer 608a. In this regard, the horizontal max block 604 may utilize two comparison operations, for example, to determine the maximum pixel value from three pixel values. The horizontal max block 604 may indicate which of the three pixel values is the maximum pixel value and may transfer the pixel values to the buffer 610. The horizontal min block 606 may comprise suitable logic, circuitry, and/or code that may enable determining a minimum pixel value from the pixel values transferred from the buffer 608b. In this regard, the horizontal min block 606 may utilize two comparison operations, for example, to determine the minimum pixel value from the three pixel values. The horizontal min block 606 may indicate which of the three pixel values is the minimum pixel value and may transfer the pixel values to the buffer 612. Other embodiments of the invention may enable implementing the horizontal max block 604 or the horizontal min block 606 by utilizing seven pixel values for determining a horizontal maximum pixel value and a horizontal minimum pixel value, for example.

The buffer 610 may comprise suitable logic, circuitry, and/or code to store pixel values and indications of the maximum pixel value transferred from the horizontal max block 604. In this regard, the size of the buffer 610 may correspond to the maximum search window size. For example, the buffer 610 may enable storing of up to 25 pixel values that may correspond to a 25×5 maximum luma search window size. The buffer 610 may comprise groups of pixel values 610a, . . . , 610i labeled A, B, C, D, E, F, G, H, and I respectively. Within each group of pixel values one pixel value is indicated to be the maximum pixel value for that group in accordance to the operations performed by the horizontal max block 604.

The buffer 612 may comprise suitable logic, circuitry, and/or code to store pixel values and indications of the minimum pixel value transferred from the horizontal min block 606. In this regard, the size of the buffer 612 may correspond to the maximum search window size. For example, the buffer 612 may enable storing of up to 25 pixel values that may correspond to a 25×5 maximum luma search window size. In this regard, the buffer 612 may comprise groups of pixel values 612a, . . . , 612i labeled A, B, C, D, E, F, G, H, and I respectively. Within each group of pixel values one pixel value is indicated to be the minimum pixel value for that group in accordance to the operations performed by the horizontal min block 606. Other embodiments of the invention may enable different implementations of the buffers 610 and 612, for example.

For luma calculations, the vertical min/max block 602 may receive five line stores of video image information and may determine the vertical minimum and the vertical maximum luma pixel values. The maximum and minimum luma pixel values may be transferred to the buffers 608a and 608b respectively. The horizontal max block 604 may compare the luma pixel values in the buffer 608a and may determine a horizontal maximum luma pixel value for that group of pixel values. Similarly, the horizontal min block 606 may compare the luma pixel values in the buffer 608b and may determine a horizontal minimum luma pixel value for that group of pixel values. The horizontal max block 604 may transfer to the buffer 610, the group of pixel values and an indication as to which pixel value in that transferred group is the maximum pixel value. The horizontal min block 606 may transfer to the buffer 612, the group of pixel values and an indication as to which pixel value in that transferred group is the minimum pixel value.

When the appropriate luma pixel value information is provided to the buffers 610 and 612, the system 600 may determine the following variance values:

Y0_var=MAX(Dₘₐₓ, Eₘₐₓ, Fₘₐₓ)−MIN(Dₘᵢₙ, Eₘᵢₙ, Fₘᵢₙ);

Y1_var=MAX(Cₘₐₓ, Dₘₐₓ, Eₘₐₓ, Fₘₐₓ, Gₘₐₓ)−MIN(Cₘᵢₙ, Dₘᵢₙ, Eₘᵢₙ, Fₘᵢₙ, Gₘᵢₙ);

Y2_var=MAX(Bₘₐₓ, Cₘₐₓ, Dₘₐₓ, Eₘₐₓ, Fₘₐₓ, Gₘₐₓ, Hₘₐₓ)−MIN(Bₘᵢₙ, Cₘᵢₙ, Dₘᵢₙ, Eₘᵢₙ, Fₘᵢₙ, Gₘᵢₙ, Hₘᵢₙ);

Y3_var=MAX(Aₘₐₓ, Bₘₐₓ, Cₘₐₓ, Dₘₐₓ, Eₘₐₓ, Fₘₐₓ, Gₘₐₓ, Hₘₐₓ, Iₘₐₓ)−MIN(Aₘᵢₙ, Bₘᵢₙ, Cₘᵢₙ, Dₘᵢₙ, Eₘᵢₙ, Fₘᵢₙ, Gₘᵢₙ, Hₘᵢₙ, Iₘᵢₙ);

where Y0_var, Y1_var, Y2_var, and Y3_var correspond to luma variance values for search windows sizes of 7×5, 13×5, 19×5, and 25×5 respectively, Aₘₐₓ through Iₘₐₓ correspond to the maximum luma pixel values in the groups of pixel values 610a, . . . , 610i respectively, and Aₘᵢₙ through Iₘᵢₙ correspond to the minimum luma pixel values in the groups of pixel values 612a, . . . , 612i respectively. Additional simplification may be achieved by utilizing maximum and minimum values calculated for determining a luma variance value when determining a next luma variance value. For example, Y1_var=MAX(Cₘₐₓ, DEFₘₐₓ, Gₘₐₓ)−MIN(Cₘᵢₙ, DEFₘᵢₙ, Gₘᵢₙ), where DEFₘₐₓ=MAX(Dₘₐₓ, Eₘₐₓ, Fₘₐₓ) and DEFₘᵢₙ=MIN(Dₘᵢₙ, Eₘᵢₙ, Fₘᵢₙ) which were calculated for determining Y0_var.

For chroma calculations, the operations performed by the system 600 may be the same or substantially similar to the operations performed for luma calculations. For chroma calculations, however, decimated search window sizes may be utilized such as 5×5, 7×5, 9×5, and 13×5, for example.

FIG. 6B is a block diagram illustrating an exemplary system for gathering horizontal image statistics to select an appropriate search window size, in accordance with an embodiment of the invention. Referring to FIG. 6B, there is shown a buffer 614 that may be utilized in connection with the horizontal min block 606 for storing chroma pixel values, U and V, and for determining the chroma variance values associated with a plurality of search window sizes. For chroma calculations, the operations performed by the system 600, and therefore by the horizontal min block 606, may be the same or substantially similar to the operations performed for luma calculations. For chroma calculations, however, search window sizes may be decimated and may be 5×5, 7×5, 9×5, and 13×5 window sizes, for example.

The buffer 614 may comprise suitable logic, circuitry, and/or code to store pixel values and indications of the minimum chroma, U and V, pixel value transferred from the horizontal min block 606. In this regard, the size of the buffer 614 may correspond to the maximum search window size. For example, the buffer 614 may enable storing of up to 13 pixel values that may correspond to a 13×5 maximum chroma search window size. The buffer 614 may comprise groups of pixel values labeled A, B, C, D, E, F, G, H, and I respectively. Within each group of pixel values one pixel value is indicated to be the minimum pixel value for that group in accordance to the operations performed by the horizontal min block 606. A similar buffer configuration may be utilized in connection with the horizontal max block 604 for storing maximum chroma pixel values. Other embodiments of the invention may enable different implementations of the buffer 614 and a corresponding buffer associated with the horizontal max block 604, for example.

When the appropriate chroma pixel value information is provided to the buffer 614 and the corresponding buffer associated with the horizontal max block 604, the system 600 may determine the following U variance values and V variance values:

U0_var=MAX(Gₘₐₓ, Hₘₐₓ)−MIN(Gₘᵢₙ, Hₘᵢₙ);

U1_var=MAX(Bₘₐₓ, Cₘₐₓ, Dₘₐₓ)−MIN(Bₘᵢₙ, Cₘᵢₙ, Dₘᵢₙ);

U2_var=MAX(Fₘₐₓ, Gₘₐₓ, Hₘₐₓ, Iₘₐₓ)−MIN(Fₘᵢₙ, Gₘᵢₙ, Hₘᵢₙ, Iₘᵢₙ);

U3_var=MAX(Aₘₐₓ, Bₘₐₓ, Cₘₐₓ, Dₘₐₓ, Eₘₐₓ)−MIN(Aₘᵢₙ, Bₘᵢₙ, Cₘᵢₙ, Dₘᵢₙ, Eₘᵢₙ);

and

V0_var=MAX(Gₘₐₓ, Hₘₐₓ)−MIN(Gₘᵢₙ, Hₘᵢₙ);

V1_var=MAX(Bₘₐₓ, Cₘₐₓ, Dₘₐₓ)−MIN(Bₘᵢₙ, Cₘᵢₙ, Dₘᵢₙ);

V2_var=MAX(Fₘₐₓ, Gₘₐₓ, Hₘₐₓ, Iₘₐₓ)−MIN(Fₘᵢₙ, Gₘᵢₙ, Hₘᵢₙ, Iₘᵢₙ);

V3_var=MAX(Aₘₐₓ, Bₘₐₓ, Cₘₐₓ, Dₘₐₓ, Eₘₐₓ)−MIN(Aₘᵢₙ, Bₘᵢₙ, Cₘᵢₙ, Dₘᵢₙ, Eₘᵢₙ);

where U0_var, U1_var, U2_var, and U3_var and V0_var, V1_var, V2_var, and V3_var correspond to chroma variance values for search windows sizes of 5×5, 7×5, 9×5, and 13×5 respectively, Aₘₐₓ through Iₘₐₓ correspond to the maximum chroma pixel values in the groups of pixel values labeled A through I respectively, and Aₘᵢₙ through Iₘᵢₙ correspond to the minimum chroma pixel values in the groups of pixel values labeled A through I respectively. Since the values for U and V are decimated, the logic, circuitry, and/or code that may be utilized for determining maximum and minimum pixel values may be shared for U and V calculations. For example, statistics for U may be generated on a clock cycle while statistics for V may be generated on a next clock cycle.

The statistical calculations for U and V chroma components may be combined as described in the following expressions:

UV0_var=MAX(U0_var, V0_var);

UV1_var=MAX(U1_var, V1_var);

UV2_var=MAX(U2_var, V2_var);

UV3_var=MAX(U3_var, V3_var);

where UV0_var, UV1_var, UV2_var, and UV3_var correspond to the combined chroma variance values for search windows sizes of 5×5, 7×5, 9×5, and 13×5 respectively.

In addition to the operations described for the system 600, the statistics block 314 in FIG. 3 may also enable black detection, control operations, and/or filter selection. Since digital image contours or bands may be more visible in dark regions of the video image, the need for filtering in bright regions of the video image may be reduced during the digital image contour removal operation by adding a programmable brightness offset value to the luma variance values. For example, the corresponding programmable offset value for each of the search window sizes may be adjusted according to the following exemplary approach:

bright_offset=0;

when ((Y>=48) && BRIGHT_{—}1) {bright_offset=1;}

when ((Y>=64) && BRIGHT_{—}2) {bright_offset=2;}

when ((Y>=96) && BRIGHT_{—}3) {bright_offset=3;}

where Y is the luma variance value, bright_offset is the corresponding offset value to Y with an initial or default value set to zero, BRIGHT_1, BRIGHT_2, and BRIGHT_3 may correspond to programmable brightness levels. The bright_offset may be varied from the initial value based on the luma variance value and/or the programmable brightness levels.

The statistics block 314 may generate appropriate control signals to enable pixel-repeat operations on the edges of a video image. However, this approach may be difficult to implement by the large window sizes. When pixel-repeat operations are difficult to implement, the digital image contour removal operations may be turn off on the video image boundaries. For example, 7×5 filtering may be enabled four pixels away from the video image edges while 25×5 filtering may be enabled thirteen (13) pixels away from the edges.

The statistics block 314 may select the appropriate filter window size based on the collected statistics. The statistics block 314 may utilize the following exemplary pseudo code for determining an appropriate filter window size for filtering digital image contours from the video image for a current pixel:

```
Y_filt = 0; // No filter
If (Y0_var + bright_offset < CORE_1) {
    Y_filt = 1; // 7×5 filter
    If (Y1_var + bright_offset < CORE_2) {
        Y_filt = 2; // 13×5 filter
        If (Y2_var + bright_offset < CORE_3) {
            Y_filt = 3; // 19×5 filter
            If (Y3_var + bright_offset < CORE_4) {
                Y_filt = 4;}}}} // 25×5 filter
UV_filt = 0; // No filter
If (UV0_var + bright_offset < CORE_1) && (Y_filt > 0) {
    UV_filt = 1; // 5×5 filter
    If (UV1_var + bright_offset < CORE_2) && (Y_filt > 1) {
        UV_filt = 2; // 7×5 filter
        If (UV2_var + bright_offset < CORE_3) && (Y_filt > 2) {
            UV_filt = 3; // 9×5 filter
                If (UV3_var + bright_offset < CORE_4) &&
                (Y_filt > 3)
                {UV_filt = 4;}}}} // 13×5 filter
```

where Y_filt may indicate the filter window size for filtering luma pixel values, UV_filt may indicate the filter window size for filtering combined chroma pixel values, CORE_1, CORE_2, CORE_3, and CORE_4 may correspond to programmable threshold values for selecting the appropriate filter window size, and && corresponds to a logical AND operation. The programmable threshold values may be programmed into registers in the statistics block 314 by, for example, the processor 104 in FIG. 1. Selection of the combined chroma filter window size may be based on the selection of the luma filter window size because small chroma amplitudes may be common, even in regions with high luma texture. The values determined for Y_filt and for UV_filt may be communicated to the filter 310. Notwithstanding the exemplary pseudo code described, other embodiments of the invention may be utilized for determining the luma and combined chroma filter window sizes.

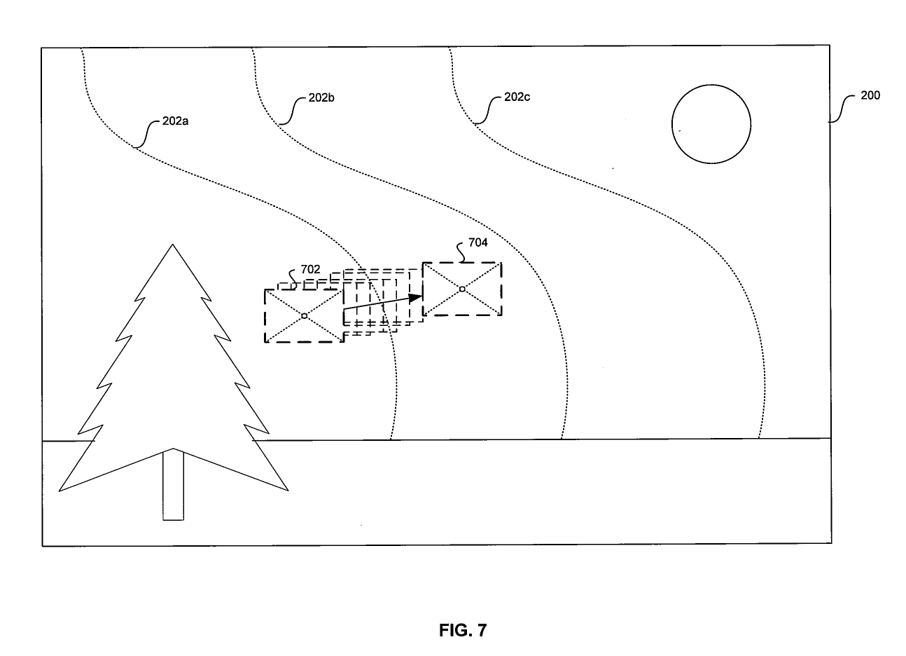

FIG. 7 is a diagram illustrating exemplary scanning of a video image for digital contour removal, in accordance with an embodiment of the invention. Referring to FIG. 7, there is shown the video image 200 described in FIG. 2 comprising a previous search window 702 and a current search window 704 in a portion of the smooth or flat region of the video image where digital image contours or bands have occurred as a result of video compression operations, for example. The previous search window 702 may be centered about a previous pixel under consideration. The statistics block 314 may have collected statistics and may have determined the appropriate filter window size for the region where the previous search window 702 is located. The current search window 704 may be centered about a current pixel under consideration in the scanning of the video image 200. The statistics block 314 may collect statistics and may determine the appropriate filter window size for the region where the current search window 704 is located. In this regard, the scanning process may have passed through the contour line 202a and the filtering operation may have been utilized to smooth out the digital image contour present in this region. A plurality of search windows may have been utilized between the previous search window 702 and the current search window 704 in the scanning process of the video image 200.

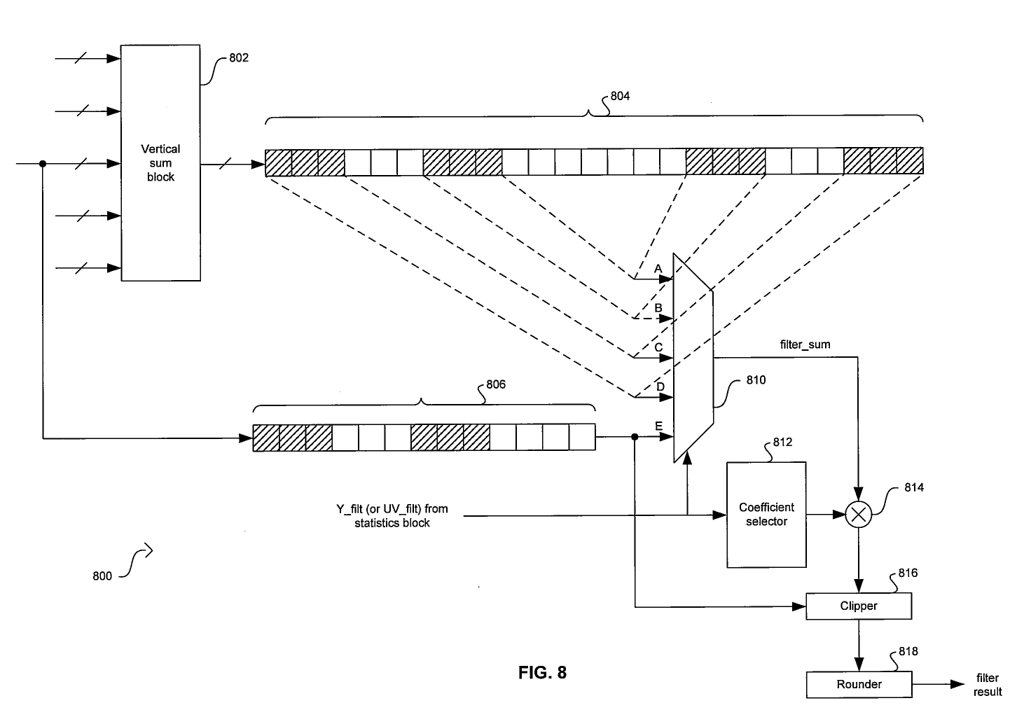

FIG. 8 is a block diagram illustrating an exemplary filter for digital contour removal, in accordance with an embodiment of the invention. Referring to FIG. 8, there is shown a system 800 that may correspond to at least a portion of the filter 310. The system 800 may comprise a vertical sum block 802, buffers 804 and 806, a horizontal sum block 810, a coefficient selector 812, a multiplier 814, a clipper 816, and a rounder 818. The system 800 may receive signals Y_filt and/or UV_filt to indicate the filter window size for luma and/or chroma filtering operations. For example, Y_filt may indicate whether or not luma filtering is to be applied to the current pixel under consideration, and/or whether or not a 7×5, 13×5, 19×5, or 25×5 luma filter window size is to be applied.

The vertical sum block 802 may comprise suitable logic, circuitry, and/or code that may enable adding the vertical line stores information for the appropriate filter window size. When the input pixel values to the vertical sum block 802 are 8-bit video data, the output of the vertical sum block may be 11-bit data, for example. The output of the vertical sum block 802 may be transferred to the buffer 804. The buffer 804 may comprise suitable logic, circuitry, and/or code that may enable storing of the vertical sum results from the vertical sum block 802. The buffer 804 may enable storing of up to 25 values corresponding to the maximum filter window size of 25×5. The values stored in the buffer 804 may be communicated to the horizontal sum block 810 for further processing. In this regard, the middle 7 values may be communicated to input A of the horizontal sum block 810 when a 7×5 filter window size is selected, the middle 13 values may be communicated to input B of the horizontal sum block 810 when a 13×5 filter window size is selected, the middle 19 values may be communicated to input C of the horizontal sum block 810 when a 19×5 filter window size is selected, and the 25 stored values may be communicated to input D of the horizontal sum block 810 when a 25×5 filter window size is selected.

The buffer 806 may comprise suitable logic, circuitry, and/or code that may enable storing the current pixel value for use when the current pixel value is to be passed through because no filtering is necessary according to the results from the statistics block 314 or when a pass-through mode is enabled in the DCR block 306. The delay provided by the buffer 806 to the horizontal sum block 810 may match the delay provided when the vertical sum block 802 and the buffer 804 are utilized.

The horizontal sum block 810 may comprise suitable logic, circuitry, and/or code that may enable adding the values received from the buffer 804 or from the buffer 806. In this regard, the Y_filt or UV_filt value received from the statistics block 314 may indicate the filter window size and the corresponding input to the horizontal sum block 810 to be selected for addition. For example, when the Y_filt value indicates that a 13×5 filter window size is to be utilized for filtering luma values for a current pixel, the horizontal sum block 810 may add the vertical sum values received from the buffer 804 via input B. In another example, when the Y_filt value indicates that no filtering is to be utilized for a current pixel, the horizontal sum block 810 may add the current pixel value received from the buffer 806 via input E. The output of the horizontal sum block 810 may be a value such as a filter_sum value, for example. When the input pixel values to the horizontal sum block 810 are 11-bit data, the output of the horizontal sum block may be 15-bit data, for example.

The coefficient selector 812 may comprise suitable logic, circuitry, and/or code that may be utilized to select a coefficient for scaling the output of the horizontal sum block 810. In this regard, the coefficient selector 812 may be utilized to scale the filter_sum value that results from adding the input values to the horizontal sum block 810. The Y_filt or UV_filt value received from the statistics block 314 may indicate to the coefficient selector 812 the appropriate coefficient for scaling the filter_sum value in accordance with the selected filter window size. For example, when the Y_filt=0 and no filtering is to occur, the filter_sum value is the value of the current pixel under consideration and a scaling factor of 1 is selected from the coefficient selector 812. For Y_filt=1, Y_filt=2, Y_filt=3, and Y_filt=4, scaling factors of 1/35, 1/65, 1/95, and 1/125 may be selected from the coefficient selector 812 respectively. A similar approach may be utilized for UV_filt values where the appropriate scaling factors may be 1, 1/25, 1/35, 1/45, and 1/65 for chroma pixel filtering applications.

The multiplier 814 may comprise suitable logic, circuitry, and/or code that may enable scaling the output of the horizontal sum block 810 with the coefficient selected from the coefficient selector 812. The clipper 816 may comprise suitable logic, circuitry, and/or code that may enable limiting the filtered value of the current pixel. In this regard, the filtered value of the current pixel may not deviate from the original value of the current pixel by more than ±FILTER_CLAMP, where the value of FILTER_CLAMP may be programmable. The rounder 818 may comprise suitable logic, circuitry, and/or code that may enable rounding the output of the clipper 816 to an appropriate bit value, such as an 8-bit output value, for example.

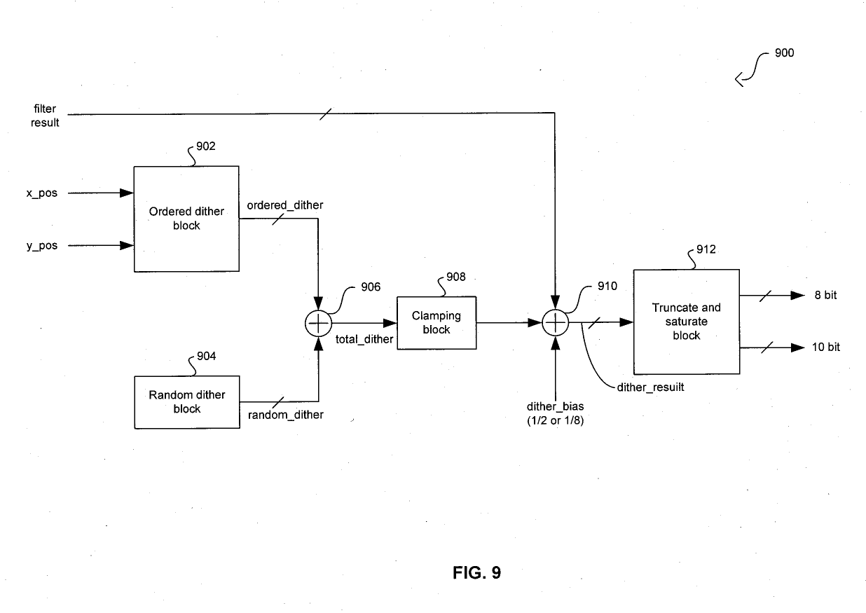

FIG. 9 is a block diagram illustrating an exemplary half-toning system, in accordance with an embodiment of the invention. Referring to FIG. 9, there is shown a system 900 that may correspond to at least a portion of the half-toning block 312 in FIGS. 3A and 3B. The system 900 may comprise an ordered dither block 902, a random dither block 904, an adder 906, a clamping block 908, an adder 910, and a truncate and saturate block 912. The system 600 may be utilized to smooth out the effects of filtering when providing the results of digital image contour removal operation as 8-bit video data, for example. In this regard, when digital image contour removal operation is to be provided as 10-bit video data, the dithering operation of the system 600 may be disabled. Dither may be applied to each color component of the current pixel under consideration.

The ordered dither block 902 may comprise suitable logic, circuitry, and/or code that may enable generating a dither value, ordered_dither, which is based on a specified location in the video image. Moreover, the value of ordered_dither may also be based on programmable register values ORDER_A, ORDER_B, INVERT_X, INVERT_Y, ALTERNATE X, and ALTERNATE_Y. The register values register values ORDER_A, ORDER_B, INVERT_X, INVERT_Y, ALTERNATE_X, and ALTERNATE_Y may be stored in registers within the ordered dither block 902 and may be programmed via the processor 104 in FIG. 1. The ALTERNATE_Y value may be utilized to create a lower frequency dither pattern and may be more generally utilized for redither, for example. The following exemplary pseudo code may be utilized to generate an ordered dither value for the operation of the system 900:

X_pos = (X&1); Y_pos = (Y&1); // take least significant bit (LSB)
If (INVERT_X) {x_pos = ~x_pos;}
If (INVERT_Y) {y_pos = ~y_pos;}
If (ALTERNATE_Y && (X&2)) {y_pos = ~y_pos;}
If (ALTERNATE_X && (Y&2)) {x_pos = ~x_pos;
If (y_pos == 0) && (x_pos == 0) {ordered_dither = +ORDER_A;}
If (y_pos == 0) && (x_pos == 1) {ordered_dither = −ORDER_A;}
If (y_pos == 1) && (x_pos == 0) {ordered_dither = −ORDER_B;}
If (y_pos == 1) && (x_pos == 1) {ordered_dither = +ORDER_B;}

where y_pose and x_pos indicated the respective vertical and horizontal positions of the current pixel under consideration in the video image, && corresponds to a logical AND operation, and & corresponds to a bitwise AND operation. The half-toning block 312 may operate in a mode, such as an AUTO_DITHER enabled mode, in which INVERT_X and INVERT_Y may change every video image in a specified order, such as [X,Y]: [0,0] [1,0] [1,1] [0,1], for example.

The random dither block 904 may comprise suitable logic, circuitry, and/or code that may enable generating a dither value, random_dither, which is randomly generated for each current pixel under consideration. The random dither operation may comprise a two-part process. For example, a three-bit random number may be generated for each color component by utilizing a 16-bit linear feedback shirt register (LFSR). Two bits from the three-bit random number may be utilized to address a four-entry look-up table (LUT) in the random dither block 904. The four values in the LUT may be RANDOM_A, RANDOM_B, RANDOM_C, and RANDOM_D, which may programmed by the processor 104, for example. The remaining bit from the three-bit random number may be utilized to indicate a sign for the a selected value from the four-entry LUT. An exemplary association between the generated three-bit random number and the contents of the four-entry LUT may be as follows:

000: +RANDOM_A, 001: +RANDOM_B, 010: +RANDOM_C, 011: +RANDOM_D,

100: −RANDOM_A, 101: −RANDOM_B, 110: −RANDOM_C, 111: −RANDOM_D.

The adder 906 may comprise suitable logic, circuitry, and/or code that may enable adding the results of the random dither block 904 and the results of the ordered dither block 902 to generate a total dither value, such as total_dither, for example. In some instances, the operations of the random dither block 904 or the ordered dither block 902 may be disabled and the total dither value may correspond to the ordered dither value or to the random dither value respectively. The clamping block 908 may comprise suitable logic, circuitry, and/or code that may enable limiting the total dither value. For example, the total dither value may be limited to ±DITHER_CLAMP, where DITHER_CLAMP is a programmable value that may be stored in a register within the half-toning block 312. In this regard, the value of DITHER_CLAMP may be programmable by the processor 104. The output of the clamping block 908 may be communicated to the adder 910. The adder 910 may comprise suitable logic, circuitry, and/or code that may enable generation of a dither result value, such as dither_result, by adding the output of the clampling block 908, the output of the filter 310, and a programmable dither bias, dither_bias, that may be programmed by the processor 104. The dither bias value may programmed to be ½ for 8-bit video systems and ⅛ for 10-bit video systems, for example.

The truncate and saturate block 912 may comprise suitable logic, circuitry, and/or code that may enable saturation of the output of the adder 910 to within the desired output bits. For example, for 8-bit video systems the truncate and saturate block 912 may truncate the output to the upper 8 bits while for 10-bit video systems the truncate and saturate block 912 may truncate the output to the upper 10 bits, which may effectively truncate the biased result from the adder 910.

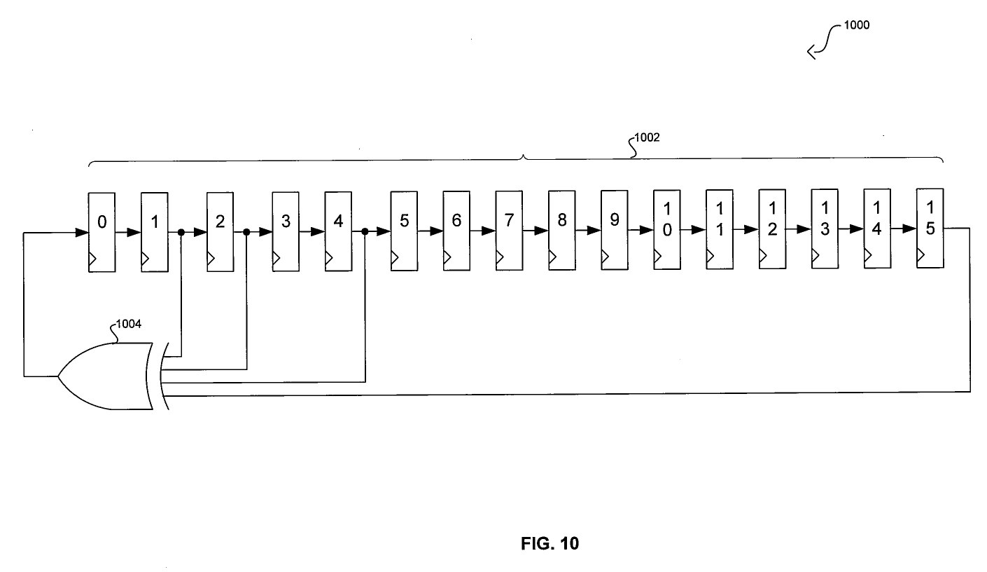

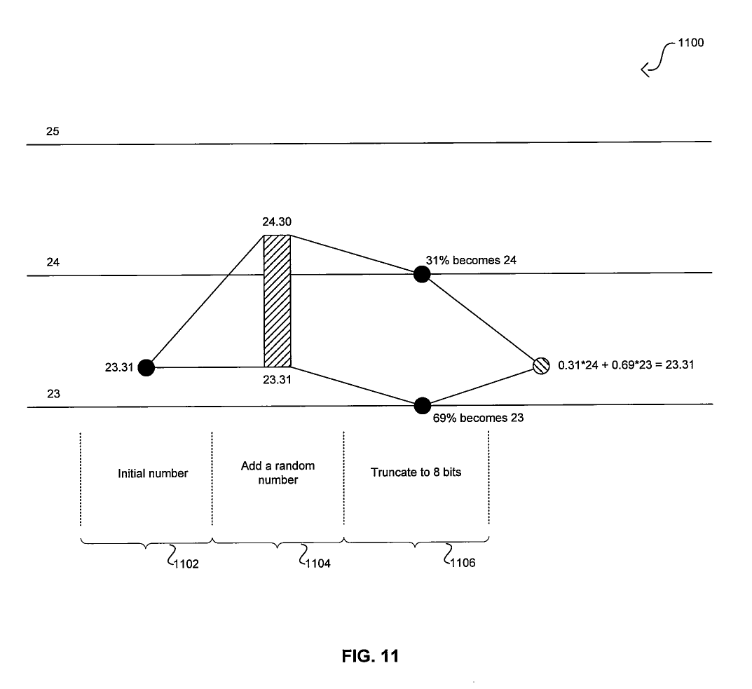

FIG. 10 is a block diagram illustrating an exemplary random dither generator, in accordance with an embodiment of the invention. Referring to FIG. 10, the random dither generator 1000 may be a 16-bit linear feedback shift register (LFSR) that may comprise a bank 1002 of 16 registers and a four-input XOR gate 1004. The 16-bit LFSR is shown to have taps at 16, 5, 3, and 2. The 16-bit LFSR may utilize a 16-bit seed value that may be programmed by the processor 104, for example. The 16-bit LFSR may operate in one of three modes, for example. When operating on a video frame, the seed value may be loaded at the start of each video frame. When operating on a video field, the seed value may be loaded every other video field. In an alternative mode, the 16-bit LFSR may not load the seed value when running. The 16-bit LFSR may utilize the polynomial (1+x²+x³+x⁵+x¹⁶). The 16-bit LFSR may need to be reset to a non-zero value and may operate at a ready-accept data rate.

The three-bit random numbers utilized by the random dither block 904 for the color components may be generated by the 16-bit LFSR as follows:

Y2=L0 (0), Y1=L2 XOR L3 (1), Y0=L11 XOR L13 (2);

Cb2=L5 XOR L8 (3), Cb1=L10 XOR L14 (4), Cb0=L1 XOR L6 (5);

Cr2=L9 XOR L15 (6), Cr1=L0 XOR L7 (7), Cr0=L4 XOR L12 (8);

where Y2, Y1, and Y0 correspond to the three luma bits, Cb2, Cb1, and Cb0 correspond to a first set of chroma bits, and Cr2, Cr1, and Cr0 correspond to a second set of chroma bits. The bits generated for the color components may be decorrelated.

FIG. 11 is a diagram illustrating an exemplary half-toning operation with random dither, in accordance with an embodiment of the invention. Referring to FIG. 11, there is shown a diagram 1100 that comprises steps 1102, 1104, and 1106 for instances when only random dither is enabled in the system 900 in FIG. 9. Step 1102 illustrates the initial pixel with an exemplary value of 23.31 that may result from filtering a current pixel in the filter 310. The filter output may be 12-bit unsigned video data. In step 1104, a random dither number may be added to the initial pixel value, where the random dither number may be generated within the random dither block 904 and may be in the range [0,1). As a result, the pixel value with the added random number may be in the range [23.31, 24.30). Step 1106 may correspond to the truncation operation of the truncate and saturate block 912 and may result in a 31% probability of an 8-bit half-toned pixel value of 24 and a 69% probability of an 8-bit half-toned pixel value of 23. The use of half-toning for systems with 8-bit video outputs may enable reduction of digital image video contours, while for systems with 10-bit video outputs, rounding the filter results to 10-bits may be sufficient to reduce digital image video contours.

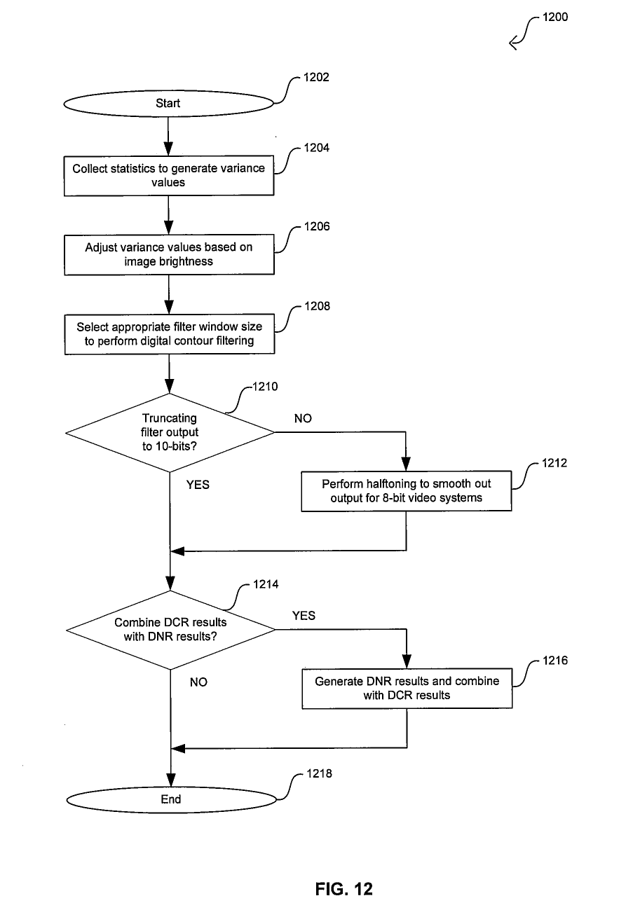

FIG. 12 is a flow diagram illustrating exemplary steps for digital contour removal in video images, in accordance with an embodiment of the invention. Referring to FIG. 12, there is shown a flow diagram 1200. In step 1204, after start step 1202, the statistics block 314 in the DCR block 306 may collect statistical information for color components regarding pixel variances in at least one search window size for a current pixel under consideration. In step 1206, a programmable offset value may be added to the luma variances in accordance with the brightness of the video image. In step 1208, the statistics block 314 may select the luma filter window size and the chroma filter window size to perform digital image contour removal in the filter 310. The filter window size may be the same to the search window size. In some instances, the statistics block 314 may indicate that no filtering may be necessary on a current pixel under consideration.

In step 1210, the DCR block 306 may determine whether the output of the filter 310 is to be truncated to 8-bit video or 10-bit video. When the output of the filter 310 is to be truncated to 8-bit video, the process may proceed to step 1212. In step 1212, the half-toning block 312 may add dither to the output of the filter 310 and may truncate the result to an 8-bit video format. After step 1212, the process may proceed to step 1214.

Returning to step 1210, when the output of the filter 310 is to be truncated to 10-bit video output, the half-toning block 312 may perform the truncation operation without applying dither to the output of the filter 310. In step 1214, the output of the DCR block 306 may be an 8-bit video or a 10-bit video. When the DNR block 316 is implemented into the artifact reduction and removal block 108 in FIG. 1 and the DNR block 316 is enabled for operation, the process may proceed to step 1216. In step 1216, the outputs of the DCR block 306 and the DNR block 316 may be combined in the combiner 318 to generate a current pixel under consideration with removed digital image contour removal and reduced mosquito noise, block noise, and/or both. Returning to step 1214, when the DNR block 316 is not implemented into the artifact reduction and removal block 108 or when it is implemented but not enabled, the process may proceed to end step 1218. In end step 1218, the output of the DCR block 306 or the output of the combiner 318 may be transferred to an output interface to format the result in accordance with the VB bus.

In another embodiment of the invention, shuffling pixels around when the differences between a current pixel under consideration and a randomly selected pixel are less than a threshold value may also enable digital image contour removal. The following exemplary algorithm may illustrate pixel shuffling:

SX=X+rand(−8, +8);

SY=Y+rand(−3, +3);

If (abs(pic(SX, SY)−pic(X, Y))<4) {pic_out(X, Y)=pic(SX, SY);}

Else {pic_out(X,Y)=pic(X, Y);}

where X is the horizontal location of the current pixel, Y is the vertical location of the current pixel, SX is the horizontal location of the randomly selected pixel, SY is the vertical location of the randomly selected pixel, and four (4) is a programmable threshold value. When the difference in pixel values is less than the threshold value, then the current pixel and the randomly selected pixel may swap values. Otherwise both pixels may retain their original pixel values. Shuffling of pixels for digital image contour removal may be suitable in software and/or embedded applications.

The approach described herein may provide an effective and simplified solution that may be implemented to reduce the presence of digital image contours without any perceptible degradation in video quality.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
detecting a digital contour in a portion of a digital video image by utilizing a selected one of a plurality of search window sizes based on a corresponding variance of said portion of said digital video image; and
removing said detected digital contour in said portion of said digital video image by utilizing a low pass filter comprising a filter size that matches said selected one of said plurality of search window sizes.

2. The method according to claim 1, comprising removing said detected digital contour and at least one of a detected mosquito noise and a detected block noise from said portion of said digital video image.

3. The method according to claim 1, comprising generating said corresponding variance for said portion of said digital video image.

4. The method according to claim 3, comprising adjusting said variance via a programmable offset value.

5. The method according to claim 3, comprising comparing said variance to a programmable threshold value.

6. The method according to claim 1, comprising half-toning said portion of said digital video image after said removal of said detected digital contour.

7. The method according to claim 6, comprising combining an ordered dither and a random dither for said half-toning of said portion of said digital video image.

8. A machine-readable storage having stored thereon, a computer program having at least one code section for video processing, the at least one code section being executable by a machine for causing the machine to perform steps comprising:
detecting a digital contour in a portion of a digital video image by utilizing a selected one of a plurality of search window sizes based on a corresponding variance of said portion of said digital video image; and
removing said detected digital contour in said portion of said digital video image by utilizing a low pass filter comprising a filter size that matches said selected one of said plurality of search window sizes.

9. The machine-readable storage according to claim 8, comprising code for removing said detected digital contour and at least one of a detected mosquito noise and a detected block noise from said portion of said digital video image.

10. The machine-readable storage according to claim 8, comprising code for generating said corresponding variance for said portion of said digital video image.

11. The machine-readable storage according to claim 10, comprising code for adjusting said variance via a programmable offset value.

12. The machine-readable storage according to claim 10, comprising code for comparing said variance to a programmable threshold value.

13. The machine-readable storage according to claim 8, comprising code for half-toning said portion of said digital video image after said removal of said detected digital contour.

14. The machine-readable storage according to claim 13, comprising code for combining an ordered dither and a random dither for said half-toning of said portion of said digital video image.

15. A system for video processing, the system comprising:
circuitry that enables detecting a digital contour in a portion of a digital video image by utilizing a selected one of a plurality of search window sizes based on a corresponding variance of said portion of said digital video image; and
circuitry that enables removing said detected digital contour in said portion of said digital video image by utilizing a low pass filter comprising a filter size that matches said selected one of said plurality of search window sizes.

16. The system according to claim 15, comprising circuitry that enables removing said detected digital contour and at least one of a detected mosquito noise and a detected block noise from said portion of said digital video image.

17. The system according to claim 15, comprising circuitry that enables generating said corresponding variance for said portion of said digital video image.

18. The system according to claim 17, comprising circuitry that enables adjusting said variance via a programmable offset value.

19. The system according to claim 17, comprising circuitry that enables comparing said variance to a programmable threshold value.

20. The system according to claim 15, comprising circuitry that enables half-toning said portion of said digital video image after said removal of said detected digital contour.

21. The system according to claim 20, comprising circuitry that enables combining an ordered dither and a random dither for said half-toning of said portion of said digital video image.

22. A system for video processing, the system comprising:
one or more circuits that utilizes a selected one of a plurality of search window sizes based on a variance of a portion of a digital video image; and
said one or more circuits utilizes, on said portion of digital video, a low pass filter comprising a filter size that matches said selected one of said plurality of search window sizes.

23. The system according to claim 22, wherein said one or more circuits removes a detected digital contour and at least one of a detected mosquito noise and a detected block noise from said portion of said digital video image.

24. The system according to claim 22, wherein said one or more circuits generates said variance for said portion of said digital video image.

25. The system according to claim 24, wherein said one or more circuits adjusts said variance via a programmable offset value.

26. The system according to claim 24, wherein said one or more circuits compares said variance to a programmable threshold value.

27. The system according to claim 22, wherein said one or more circuits half-tones said portion of said digital video image after removal of a detected digital contour.

28. The system according to claim 27, wherein said one or more circuits combines an ordered dither and a random dither for said half-toning of said portion of said digital video image.

29. A method for video processing, the method comprising:
utilizing a selected one of a plurality of search window sizes based on a variance of a portion of a digital video image; and
low pass filtering said portion of a digital video image, using a filter size that matches said selected one of said plurality of search window sizes.

30. The method according to claim 29, comprising removing a detected digital contour and at least one of a detected mosquito noise and a detected block noise from said portion of said digital video image.

31. The method according to claim 29, comprising generating said variance for said portion of said digital video image.

32. The method according to claim 31, comprising adjusting said variance via a programmable offset value.

33. The method according to claim 31, comprising comparing said variance to a programmable threshold value.

34. The method according to claim 29, comprising half-toning said portion of said digital video image after said removal of said detected digital contour.

35. The method according to claim 34, comprising combining an ordered dither and a random dither for said half-toning of said portion of said digital video image.
